(19) United States
(12) Patent Application Publication
(10) Pub. No.: US 2019/0225296 A1
(43) Pub. Date: Jul. 25, 2019

(54) HANDLEBAR TAPE CAPABLE OF IDENTIFYING THICKNESS CHANGE

(71) Applicant: CHILILON ENTERPRISE CO., LTD., Taichung City (TW)

(72) Inventor: Chiaming Hsu, Taichung City (TW)

(21) Appl. No.: 16/244,741

(22) Filed: Jan. 10, 2019

(30) Foreign Application Priority Data
Jan. 23, 2018 (TW) 107102373

(51) Int. Cl. B62K 21/26; B62K 21/12

(52) U.S. Cl. CPC B62K 21/26; B32B 2405/00; B62K 21/12

(57) ABSTRACT

A handlebar tape includes a strip-shaped main body made of silicone. A longitudinal direction and a lateral direction are defined along a long side and a short side of the main body, respectively. When the main body is stretched along the longitudinal direction, the main body is changed from a first state to a second state, and a length and a thickness of the main body are changed correspondingly. An identification pattern is disposed on a surface of the main body and forms at least one geometric shape. When the main body is in the first state, a width in the longitudinal direction of the geometric shape is less than a width in the lateral direction. When the main body is in the second state, the width in the longitudinal direction of the geometric shape is equal to the width in the lateral direction.

### FIELD OF THE INVENTION

The present invention relates to a bicycle handlebar tape, and more particularly to a handlebar tape capable of identifying a thickness change.

### BACKGROUND OF THE INVENTION

The front of a bicycle is provided with a handlebar for the user to control the traveling direction. Especially, the handlebar of a racing bicycle has a flat portion and a curved portion. The flat portion of the handlebar is suitable for a general riding, and the user can ride in a labor-saving posture to adjust the physical strength. The cured portion of the handlebar is suitable for a sprinting riding, and the user grips the curved portion in a forward leaning posture to pedal the bicycle with all his/her strength. For the above two kinds of riding, the handlebar tapes wrapped around the flat portion and the curved portion of the handlebar have different functional requirements. Generally, the handlebar tape used for the flat portion of the handlebar needs a softer and thicker material, so that the user can grip the handlebar easily to reduce the pressure on the palm. The handlebar tape used for the curved portion of the handlebar needs a thin and non-deformable material, so that the user can ensure the force feedback from the handlebar to enhance the handling of the bicycle.

There are various materials for the handlebar tape, such as PU, EVA foam, leather, cork, plastic or silicone, which have different material properties in hardness and extension. The functional characteristics required for the flat portion and the curved portion of the handlebar are different. It is difficult to have a material that meets the needs of both. Therefore, the user must purchase two suitable handlebar tapes, which brings inconvenience in purchase. Accordingly, the inventor of the present invention has devoted himself based on his many years of practical experiences to solve these problems.

### SUMMARY OF THE INVENTION

The primary object of the present invention is to provide a handlebar tape. The handlebar tape is provided with a pattern for identifying the thickness change of the handlebar tape after stretching according to the deformation property of the material. It is convenient for the user to observe and know the degree of the handlebar tape wrapped around the bicycle handlebar. The invention can be used for different portions of the bicycle handlebar, meeting the functional requirements of the different portions of the bicycle handlebar.

In order to achieve the above object, a handlebar tape capable of identifying a thickness change is provided. The handlebar tape comprises a strip-shaped main body and an identification pattern. The strip-shaped main body is made of silicone. The main body has a long side and a short side. A longitudinal direction and a lateral direction are defined along the long side and the short side of the main body, respectively. When the main body is stretched along the longitudinal direction, the main body is changed from a first state to a second state, and a length and a thickness of the main body are changed correspondingly. The identification pattern is disposed on a surface of the main body. The identification pattern forms at least one geometric shape. The geometric shape is deformed as the main body is stretched, thereby identifying a change of the thickness of the main body. When the main body is in the first state, a width in the longitudinal direction of the geometric shape is less than a width in the lateral direction of the geometric shape. When the main body is in the second state, the width in the longitudinal direction of the geometric shape is equal to the width in the lateral direction of the geometric shape.

In an embodiment, the identification pattern is composed of ribs protruding from the surface of the main body.

In an embodiment, the identification pattern is composed of grooves formed on the surface of the main body.

In an embodiment, the identification pattern forms a plurality of geometric shapes arranged in a line along the longitudinal direction.

In an embodiment, when the main body is in the first state, the geometric shape is a rhombic, elliptical or rectangular shape.

### BRIEF DESCRIPTION OF THE DRAWINGS

FIG. 1 is a schematic view of a first embodiment of the present invention before stretching;

FIG. 2 is a schematic view of the first embodiment of the present invention after stretching;

FIG. 3 is a schematic view of the first embodiment of the present invention when in use;

FIG. 4 is a schematic view of a second embodiment of the present invention, showing the change before and after stretching;

FIG. 5 is a schematic view of a third embodiment of the present invention, showing the change before and after stretching; and

FIG. 6 is a schematic view of a fourth embodiment of the present invention, showing the change before and after stretching.

### DETAILED DESCRIPTION OF THE PREFERRED EMBODIMENTS

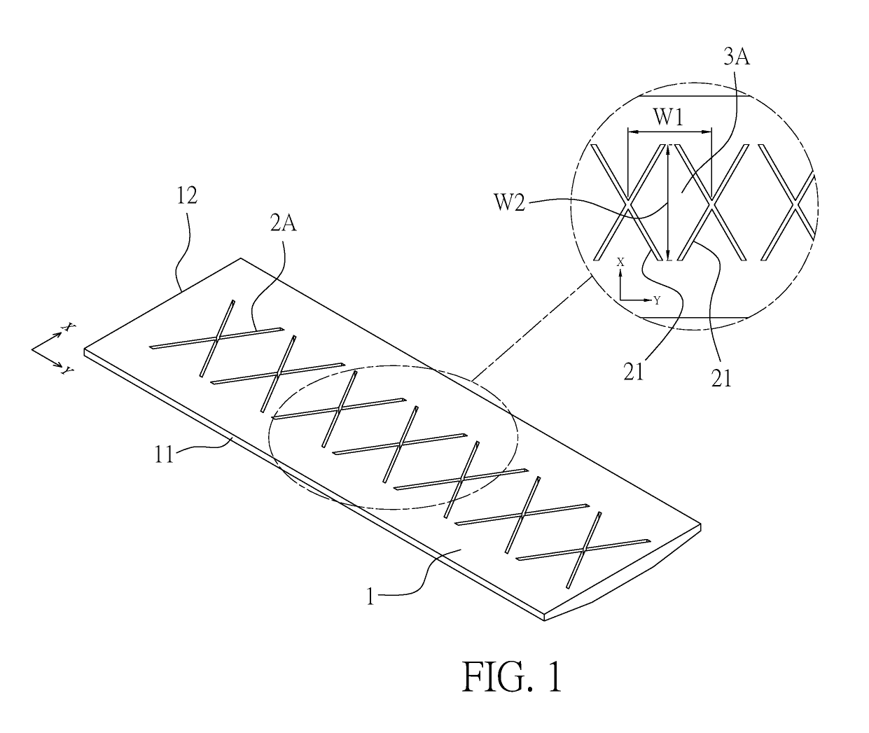

Referring to FIG. 1, the present invention discloses a handlebar tape capable of identifying a thickness change, comprising a strip-shaped main body 1. The man body 1 is made of silicone and has elasticity, and may be deformed after being stressed. The main body 1 has a long side 11 and a short side 12. A longitudinal direction Y and a lateral direction X are defined along the long side 11 and the short side 12 of the main body 1, respectively. When the main body 1 is wrapped around the handlebar of a bicycle, a change in length along the longitudinal direction Y occurs, and the thickness of the main body 1 decreases as the increase in length.

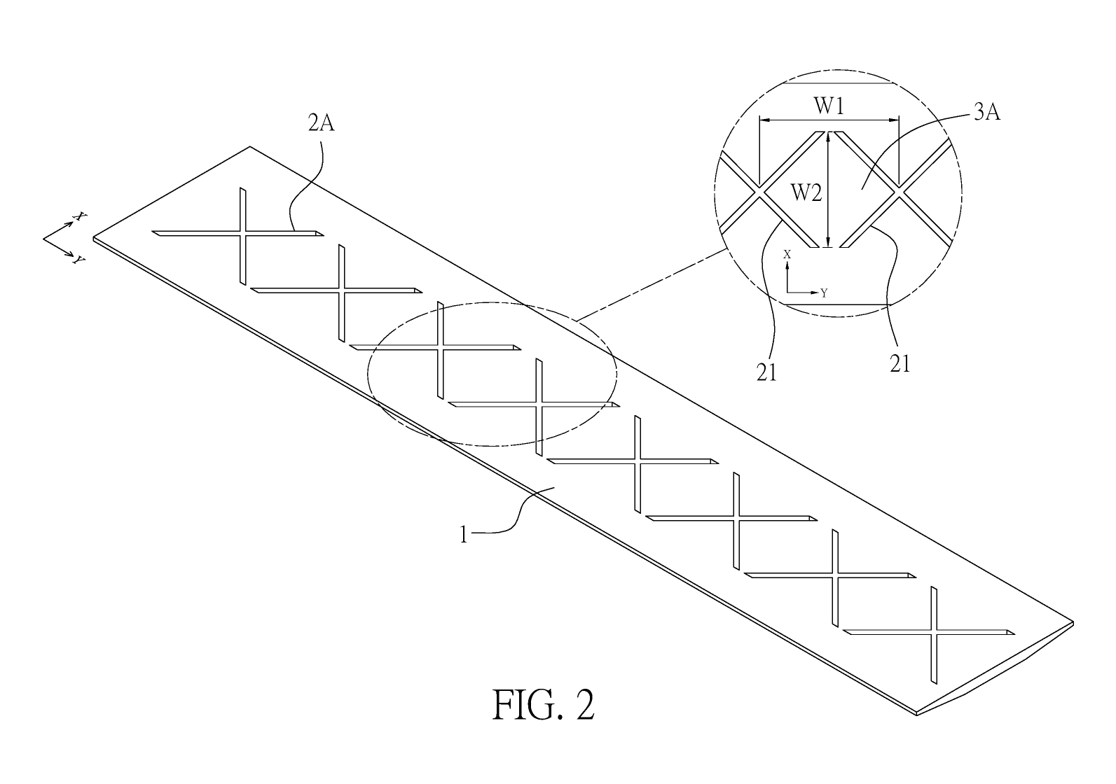

When the main body 1 is stretched along the longitudinal direction Y, the main body 1 is changed from a first state to a second state. In the first state, the main body 1 has a shorter length and a greater thickness, as shown in FIG. 1. In the second state, the main body 1 has a longer length and a less thickness as shown in FIG. 2.

As shown in FIG. 1 and FIG. 2, the surface of the main body 1 is provided with an identification pattern 2A which forms at least one geometric shape 3A. The geometric shape 3A produces a corresponding shape change as the main body 1 is stretched. In this embodiment, the identification pattern 2A is arranged on the main body 1 in a line along the longitudinal direction Y by a string of “X” designs 21. The geometric shape 3A is defined between every adjacent two of the designs. The geometric shape 3A has a width W1 in the longitudinal direction Y and a width W2 in the lateral direction X. When the main body 1 is in the first state, as shown in FIG. 1, the width W1 in the longitudinal direction of the geometric shape 3A is less than the width W2 in the lateral direction of the geometric shape 3A, thereby forming a rhombic shape. When the main body 1 is in the second state, as shown in FIG. 2, the geometric shape 3A is changed, and the width W1 in the longitudinal direction is equal to the width W2 in the lateral direction, thereby forming a square shape.

The identification pattern 2A includes two embodiments in the present invention, one of which is composed of ribs protruding from the surface of the main body 1, and the other is composed of grooves formed on the surface of the main body 1. Due to the deformable characteristic of the main body 1, the ribs or grooves are deformed with the stretch of the main body 1, resulting in a change of the shape of the geometric shape 3A.

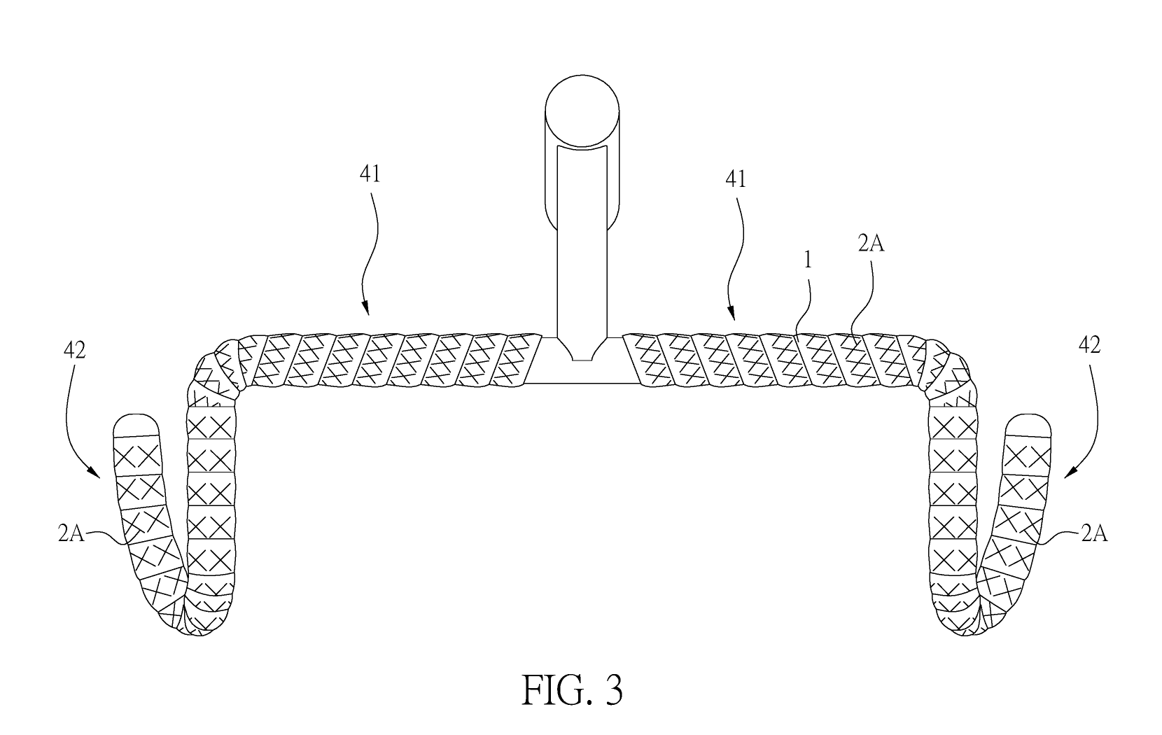

FIG. 3 shows the actual use of the present invention. For the functional requirement of the flat portion 41 of the bicycle handlebar, the main body 1 is wrapped around the flat portion 41 in the first state with a lower degree of stretching to obtain a thicker covering. At this time, the user can identify that the main body 1 is indeed in the first state through the rhombic geometric shape formed by the identification pattern 2A. On the other hand, for the functional requirement of the curved portion 42 of the bicycle handlebar, the main body 1 is wrapped around the curved portion 42 in the second state with a higher degree of stretching to obtain a thinner covering. At this time, the user can identify that the main body 1 is indeed in the second state through the square geometric shape formed by the identification pattern 2A.

Through the above description, it can be seen that the continuous change of the geometric shape caused by the main body 1 during the process of stretching the main body 1 can be used to identify the change of the thickness of the main body 1 so that the user can stretch the main body 1 for an appropriate length according to the change of the geometric shape. The most important feature of the present invention is that the user's ability to identify an “ortho” geometric shape, that is, the width W1 in the longitudinal direction is equal to the width W2 in the lateral direction is obviously higher than that of “non-ortho” geometric shape, that is, one of specific geometric shapes under the condition that the width W1 in the longitudinal direction is less than the width W2 in the lateral direction. Thus, the identification pattern 2A is designed to form an “ortho” geometric shape when the main body 1 is in the second state. When the user stretches the main body 1, it is easy for the user to know that the main body 1 has been stretched to an appropriate degree, as long as the user sees the “ortho” geometric shape. This is very convenient for use.

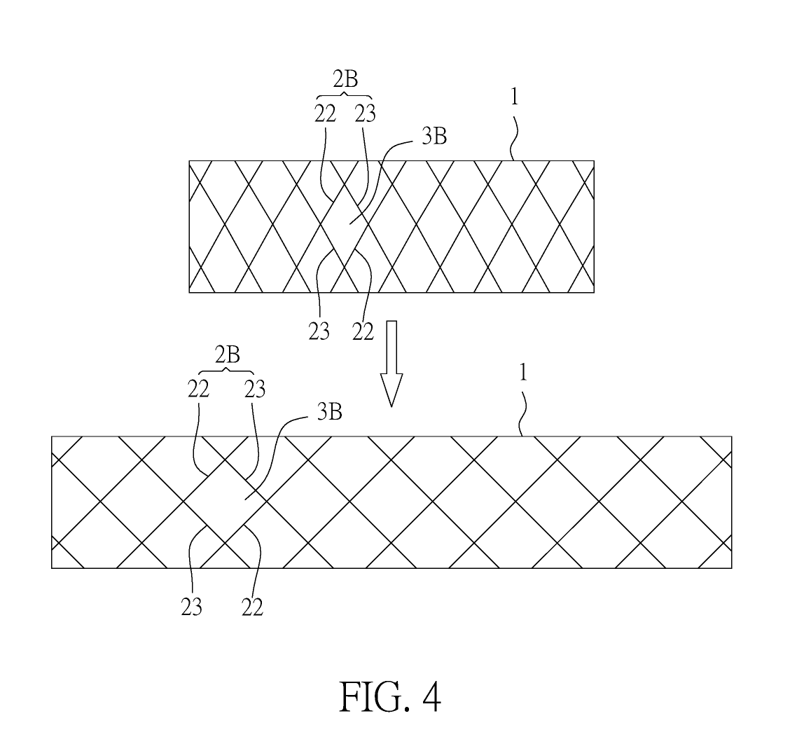

FIG. 4 shows a second embodiment of the present invention. The second embodiment is based on the structure of the first embodiment described above, and the shape of the identification pattern 2B is changed. In the second embodiment, the identification pattern 2B is composed of a plurality of parallel first straight lines 22 intersecting a plurality of parallel second straight lines 23. A geometric shape 3B is defined between every adjacent two of the first straight lines 22 and every adjacent two of the second straight lines 23. The geometric shape 3B is rhombic when the main body 1 is in the first state. The geometric shape 3B is square when the main body 1 is in the second state.

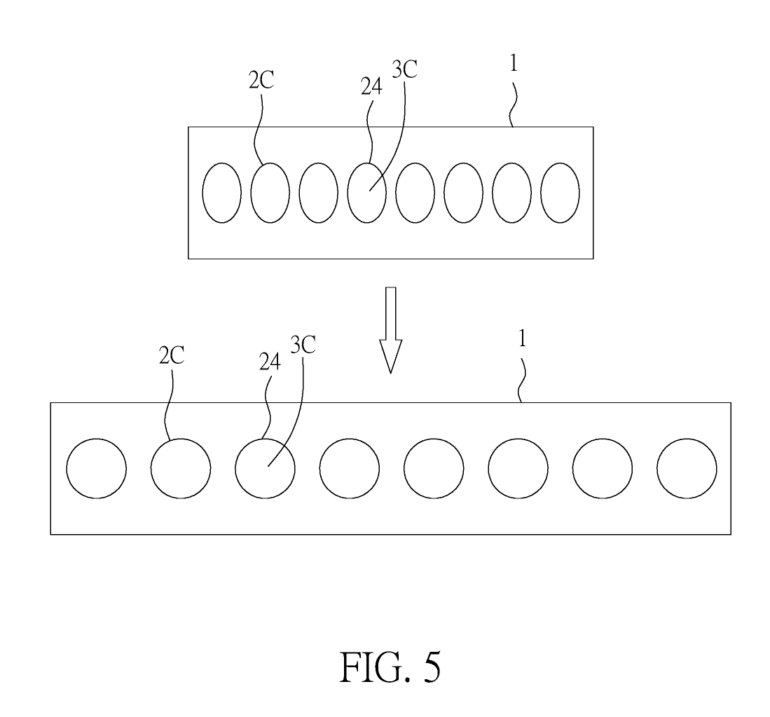

FIG. 5 shows a third embodiment of the present invention. The third embodiment is based on the structure of the first embodiment described above, and the shape of the identification pattern 2C is changed. In the third embodiment, the identification pattern 2C is composed of a plurality of annular designs 24. A geometric shape 3C is enclosed in the annular design 24. The geometric shape 3C is elliptical when the main body 1 is in the first state. The geometric shape 3C is circular when the main body 1 is in the second state.

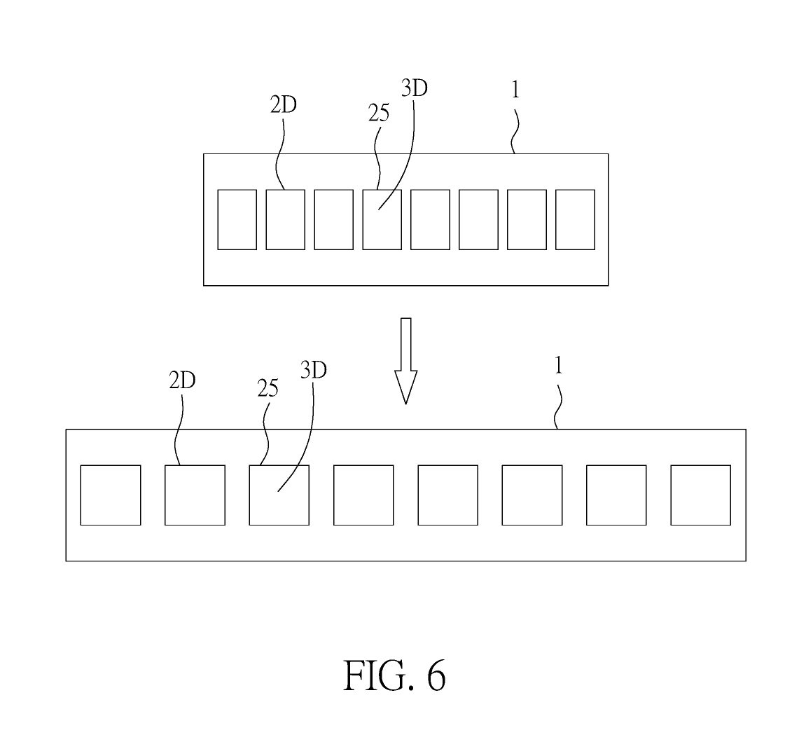

FIG. 6 shows a fourth embodiment of the present invention. The fourth embodiment is based on the structure of the first embodiment described above, and the shape of the identification pattern 2D is changed. In the fourth embodiment, the identification pattern 2C is composed of a plurality of annular designs 25. A geometric shape 3D is enclosed in the annular design 25. The geometric shape 3D is rectangular when the main body 1 is in the first state. The geometric shape 3D is square when the main body 1 is in the second state.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A handlebar tape, comprising:
a strip-shaped main body made of silicone, the main body having a long side and a short side, a longitudinal direction and a lateral direction being defined along the long side and the short side of the main body respectively, wherein when the main body is stretched along the longitudinal direction, the main body is changed from a first state to a second state, and a length and a thickness of the main body are changed correspondingly;
an identification pattern, disposed on a surface of the main body; the identification pattern forming at least one geometric shape, the geometric shape being deformed as the main body is stretched, thereby identifying a change of the thickness of the main body; wherein when the main body is in the first state, a longitudinal width of the geometric shape is less than a lateral width of the geometric shape; when the main body is in the second state, the longitudinal width of the geometric shape is equal to the lateral width of the geometric shape.

2. The handlebar tape as claimed in claim 1, wherein the identification pattern is composed of ribs protruding from the surface of the main body.

3. The handlebar tape as claimed in claim 1, wherein the identification pattern is composed of grooves formed on the surface of the main body.

4. The handlebar tape as claimed in claim 1, wherein the identification pattern forms a plurality of geometric shapes arranged in a line along the longitudinal direction.

5. The handlebar tape as claimed in claim 1, wherein when the main body is in the first state, the geometric shape is a rhombic, elliptical or rectangular shape.
